(19) United States
(12) Patent Application Publication
(10) Pub. No.: US 2026/0132055 A1
(43) Pub. Date: May 14, 2026

(54) RECREATIONAL WATER AUTO-BOOST METHODS AND SYSTEMS

(71) Applicant: King Technology, Inc., Minnetonka, MN (US)

(72) Inventors: Daniil A. Rezekulov, Savage, MN (US); Daniel P. Longhenry, Bloomington, MN (US)

(21) Appl. No.: 19/384,237

(22) Filed: Nov. 10, 2025

Related U.S. Application Data
(60) Provisional application No. 63/719,319, filed on Nov. 12, 2024.

(51) Int. Cl. C02F 1/00; C02F 1/467; C02F 103/42

(52) U.S. Cl. CPC C02F 1/008; C02F 1/4674; C02F 2103/42; C02F 2201/4612; C02F 2209/006; C02F 2209/02; C02F 2209/40; C02F 2209/42; C02F 2303/04

(57) ABSTRACT

The invention provides an automated method for preemptively inhibiting microorganism growth in a recreational body of water, such as a pool, hot tub, or spa. The method comprises initiating an increased sanitizing and/or oxidizing operation for the water as an automated response to one or more trigger conditions. The trigger condition(s) is/are selected from: a direct occupancy signal, a water motion signal, a water level signal, a vibration signal, a bather-use jets operation, and a bather-use heater operation.

### RELATED APPLICATIONS

This application claims priority to U.S. Provisional Ser. No. 63/719,319 , filed Nov. 12, 2024, the entire contents which are incorporated herein by reference.

### TECHNICAL FIELD

This disclosure relates generally to methods and systems for managing recreational bodies of water. More specifically, this disclosure relates to methods and systems for inhibiting microorganism growth in a recreational body of water, such as a pool, hot tub, or spa.

### BACKGROUND

When maintaining recreational bodies of water (e.g., pools, hot tubs, and spas), it is desirable to inhibit the growth of bacteria and other microorganisms in the water. In some cases, a hot tub or spa is equipped with a chlorine or bromine generator for sanitizing the water. Some of these generators include a boost button, which is typically activated (e.g., pressed) by a bather after using the hot tub or spa. This is done to combat the lower sanitizing/oxidizing power that results in the water from the bather load. While these boost buttons can be helpful, there can still be problems. Consider that bacteria growth occurs exponentially, whereas sanitizer/oxidizer delivery rates tend to be increased linearly. After one or more bathers use a hot tub or spa, if its sanitizer/oxidizer level has been reduced to 0 but there is still a biocidal load, then activating the boost button (e.g., to linearly increase delivery of chlorine or bromine) may not catch up with the exponential bacterial growth. More generally, because bacteria tend to grow exponentially, it can be difficult to deliver effective post-use sanitizer/oxidizer doses in a recreational body of water by linearly increasing the sanitizer/oxidizer delivery. Furthermore, conventional boost buttons do not eliminate certain user errors, such as forgetting to press the boost button after bathing in a hot tub or spa. Once bacteria growth in a recreational body of water has gone too far, it may be necessary to drain and refill the water, perhaps also requiring plumbing maintenance to address the bacteria and/or other microorganisms.

### SUMMARY

In some embodiments, the invention provides an automated method for preemptively inhibiting microorganism growth in a recreational body of water, such as a pool, hot tub, or spa. The method comprises initiating an increased sanitizing and/or oxidizing operation for the water as an automated response to one or more trigger conditions. Preferably, the trigger condition(s) is/are selected from: a direct occupancy signal, a water motion signal, a water level signal, a vibration signal, a bather-use jets operation, and a bather-use heater operation.

One group of embodiments provides an automated method for preemptively inhibiting microorganism growth in a recreational body of water, such as a pool, hot tub, or spa. The method comprises initiating an increased sanitizing and/or oxidizing operation for the water as an automated response to one or more trigger conditions. In the present group of embodiments, the trigger condition(s) is/are selected from: a direct occupancy signal, a water motion signal, a water level signal, and a vibration signal.

Another group of embodiments provides an automated method for preemptively inhibiting microorganism growth in a recreational body of water, such as a pool, hot tub, or spa. The method comprises initiating an increased sanitizing and/or oxidizing operation for the water as an automated response to one or more trigger conditions. In the present group of embodiments, the trigger condition(s) is/are selected from: a bather-use jets operation and a bather-use heater operation.

Some embodiments of the present disclosure provide an automated method comprises initiating an increased sanitizing and/or oxidizing operation for the water as an automated response to one or more trigger conditions. Preferably, the trigger condition(s) is/are selected from: a direct occupancy signal, a water motion signal, a water level signal, a vibration signal, a bather-use jets operation, and a bather-use heater operation.

Thus, the present disclosure provides an automated method for preemptively inhibiting microorganism growth in a recreational body of water, such as a pool, hot tub, or spa. In some embodiments, the method comprises initiating an increased sanitizing and/or oxidizing operation for the water as an automated response to two or more trigger conditions. Preferably, the trigger conditions are selected from: a direct occupancy signal, a water motion signal, a water level signal, a vibration signal, a bather-use jets operation, and a bather-use heater operation. In some of the present embodiments, the two or more trigger conditions are selected from: at least one of (i) a direct occupancy signal, a water motion signal, a water level signal, and a vibration signal: and at least one of (ii) a bather-use jets operation and a bather-use heater operation. In embodiments of this nature, the recreational body of water preferably comprises a swimming pool, hot tub, or spa equipped with a controller, and the controller is configured to receive two or more auto-boost sensory inputs selected from: at least one of: (a) a direct occupancy signal, a water motion signal, a water level signal, and a vibration signal: and at least one of: (b) a temperature signal, a blower signal, and a pump speed. In more detail, the swimming pool, hot tub, or spa preferably in such embodiments preferably is equipped with a direct occupancy sensor, a water motion sensor, a water level sensor, and/or a vibration sensor. In certain embodiments, the recreational body of water comprises a hot tub or spa equipped with a controller, the two or more trigger conditions include the bather-use heater operation, and the controller is configured to receive an auto-boost sensory input comprising a water temperature signal. Additionally or alternatively, the two or more trigger conditions can include the bather-use jets operation, and the controller is configured to receive one or more auto-boost sensory inputs comprising a blower signal and/or a pump speed.

While multiple embodiments are disclosed herein, still other embodiments of the present disclosure will become apparent to those skilled in the art from the following detailed description, which describes illustrative embodiments of the disclosure. Accordingly, the detailed description is to be regarded as illustrative in nature and not restrictive.

### BRIEF DESCRIPTION OF DRAWINGS

FIG. 1 is a schematic illustration of a logic tree for a controller of a system comprising a recreational body of water, where the controller is configured to receive one or more auto-boost sensory inputs selected from the group consisting of a direct occupancy signal, a water motion signal, a water level signal, and a vibration signal in accordance with a first subgroup of embodiments of the present disclosure;

FIG. 2 is a schematic illustration of a logic tree for a controller of a system comprising a recreational body of water, where the controller is configured to receive one or more auto-boost sensory inputs selected from the group consisting of a temperature signal, a blower signal, and a pump speed in accordance with a second subgroup of embodiments of this disclosure;

FIG. 3 is a schematic illustration of a logic tree for a controller of a system comprising a recreational body of water, where the controller is configured to receive, as auto-boost sensory inputs, a blower signal and a pump speed in accordance with certain embodiments of this disclosure;

FIG. 4 is a schematic illustration of a logic tree for a controller of a system comprising a recreational body of water, where the controller is configured to receive, as an auto-boost sensory input, a temperature signal in accordance with certain embodiments of this disclosure; and

FIG. 5 is a schematic illustration of a logic tree for a controller of a system comprising a recreational body of water, where the controller is configured to receive one or more auto-boost sensory inputs selected from the group consisting of a direct occupancy signal, a water motion signal, a water level signal, a vibration signal, a temperature signal, a blower signal, and a pump speed in accordance with various embodiments of the present disclosure.

### DETAILED DESCRIPTION

The following detailed description is to be read with reference to the drawings. The drawings exemplify certain preferred embodiments and are not intended to limit the scope of the invention. Skilled artisans will recognize that the examples and embodiments described herein have many useful alternatives that fall within the scope of the invention.

So that the present disclosure may be more readily understood, certain terms may be defined. Unless otherwise defined, all technical and scientific terms used herein have the meaning commonly understood by one of ordinary skill in the art to which the technology of this disclosure pertains.

Furthermore, in the present disclosure, anywhere the terms “comprising” or “comprises” are used, those terms have their ordinary open-ended meaning. In addition, where appropriate, the disclosure at each such location is to be understood to also disclose that it may, as an alternative, “consist essentially of” or “consist of.”

In some embodiments, the invention provides an automated method for preemptively inhibiting microorganism growth in a recreational body of water. A recreational body of water is understood to comprise a body of water (e.g., a pool, hot tub, spa, or the like) in which a person wholly or partially immerses themself. In any embodiment of the present disclosure, the recreational body of water can optionally be a pool, hot tub, or spa, including a swim spa.

The present method comprises initiating an increased sanitizing and/or oxidizing operation for the water as an automated response to one or more trigger conditions. Preferably, the one or more trigger conditions are selected from: a direct occupancy signal, a water motion signal, a water level signal, a vibration signal, a bather-use jets operation, and a bather-use heater operation.

Thus, the one or more trigger conditions are signals, an operation, or both indicating that one or more bathers have entered the water or are preparing to enter the water.

The automated response initiates an increased sanitizing and/or oxidizing operation for the water preemptively, rather than initiating such an operation later (e.g., after bather use) and attempting to catch up with the growth of bacteria and/or other microorganisms. Thus, the present methods can advantageously get ahead of unwanted microorganism growth that can occur when bather loads reduce the sanitizing and/or oxidizing power of the water. Furthermore, the automated nature of these methods and systems eliminates certain user errors, such as forgetting to press a boost button after bathing. The present invention therefore beneficially increases the ability of homeowners and others who use and/or manage recreational bodies of water to more easily maintain sanitary water conditions.

One subgroup of embodiments involves a direct occupancy signal. In embodiments of this nature, the recreational body of water is equipped with a direct occupancy sensor. Thus, in certain embodiments, a swimming pool, hot tub, or spa is equipped with a direct occupancy sensor. When provided, the direct occupancy sensor preferably is selected from the group consisting of a sonar sensor, a LiDAR sensor, a RADAR sensor, an optical sensor, and a thermal/infrared sensor.

When a sonar sensor is used, the recreational body of water preferably is equipped with an ultrasonic sensor. When provided, the ultrasonic sensor preferably is configured such that, when one or more bathers enter the water, the sensor determines a different distance between it and the nearest obstacle (compared with the distance the sensor determines when there are no bathers in the water). The sensor does this by emitting sound waves that then bounce off the nearest object in their path, such as an opposite wall of a hot tub or spa.

Thus, in certain embodiments, a swimming pool, hot tub, or spa is equipped with an ultrasonic sensor. In embodiments of this nature, when no bathers are present in the water, the nearest object may be the opposite wall of the pool, hot tub, or spa (in such cases, the sensor will register the unoccupied, default distance), whereas when one or more bathers enter the water and reflect sound waves back to a receiver of the sensor, the distance determined by the sensor will be shorter than the unoccupied, default distance. In such cases, when the sensor reads a distance shorter than the default distance, the sensor (or a controller operably coupled with the sensor) preferably generates a signal that triggers an increased sanitizing and/or oxidizing operation for the water.

In embodiments where a hot tub or spa is equipped with one or more ultrasonic sensors, the sensor(s) can optionally be mounted on (and/or alongside) a shell of the hot tub or spa. In such cases, the sensor(s) preferably are configured to emit sound waves underwater. In these and other cases, the ultrasonic sensor preferably does not project inwardly into the water in a manner likely to get caught on bathers. Instead, it preferably is received in a recessed or otherwise protected space such that it is recessed or at least flush, e.g., relative to an adjacent region of the shell of the hot tub or spa, and/or adjacent to a housing, shroud, or other protective body mounted to (or otherwise integrated into) the shell.

If desired, a recreational body of water can be equipped with a plurality of underwater sonar sensors. In certain embodiments of this nature, two or more underwater ultrasonic sensors are provided at two or more locations spaced apart along the perimeter of a hot tub or spa. In swimming pool embodiments, it may be desirable to provide multiple sensors at multiple locations along the perimeter of the pool, e.g., one underwater sensor positioned every several feet, and/or multiple underwater sensors located at strategic positions, such as near designated pool entries, at a deep end of the pool, or both.

One non-limiting example of an underwater ultrasonic sensor is the IP68 underwater sensor, which is commercially available from Zhiwei Robotics Corp. (dba DFRobot Corporation), located in Shanghai, China.

When a LiDAR sensor is used, the recreational body of water preferably is equipped with such a sensor. The LiDAR sensor, for example, can emit radiation (e.g., laser) pulses, which then bounce off the nearest object in the path of the radiation and thereby reflect back to a receiver of the sensor. The time it takes for the pulses to return to the sensor is used to calculate the distance between the sensor and the nearest object in the path of the radiation. In some embodiments involving a hot tub or spa, when no bathers are present in the water, the nearest object may be the opposite wall of a pool, hot tub, or spa (in such cases, the sensor will register the unoccupied, default distance), whereas when one or more bathers enter the water and reflect the signal back to the sensor, the distance determined by the sensor will be shorter than the unoccupied, default distance. When the sensor reads a distance shorter than the default distance, the sensor (or a controller operably coupled with the sensor) preferably generates a signal that triggers an increased sanitizing and/or oxidizing operation for the water.

The radiation emitted by LiDAR sensors commonly is ultraviolet or visible radiation. In addition, the emitted radiation preferably is in laser form. When a LiDAR sensor is configured to emit radiation underwater, the radiation can optionally be visible radiation (preferably in laser form) in the green range of wavelengths, such as about 532 nm. It is to be appreciated, however, that the detection of one or more bathers can advantageously be performed with LiDAR using radiation of various other wavelengths.

In embodiments where a hot tub or spa is equipped with one or more LiDAR sensors, the sensor(s) can optionally be mounted on (and/or alongside) a shell of the hot tub or spa. In such cases, the sensor(s) preferably are configured to emit laser pulses underwater. If desired, the (or each) sensor can be mounted operably in a recessed space that is bounded by the shell of the hot tub or spa. In these and other cases, the LiDAR sensor preferably does not project inwardly into the water in a manner likely to get caught on bathers. Instead, it preferably is received in a recessed or otherwise protected space such that it is recessed or at least flush, e.g., relative to an adjacent region of the shell of the hot tub or spa, and/or adjacent to a housing, shroud, or other protective body mounted to (or otherwise integrated into) the shell.

If desired, a recreational body of water can be equipped with a plurality of underwater LiDAR sensors. In certain embodiments of this nature, two or more underwater LiDAR sensors are provided at two or more locations spaced apart along the perimeter of a hot tub or spa. In swimming pool embodiments, it may be desirable to provide multiple sensors at multiple locations along the perimeter of the pool, e.g., one underwater sensor positioned every several feet, and/or multiple underwater sensors located at strategic positions, such as near designated pool entries, at a deep end of the pool, or both.

One exemplary underwater LiDAR sensor is the CPJRobot PoE 270°30FPS Waterproof LiDAR Sensor (20 m), which is commercially available from Shanghai CPJ Robot Co., Ltd., (Shanghai, China). Another exemplary underwater LiDAR sensor is the Insight Nano scanner, which is commercially available from Voyis Imaging Inc. (Waterloo, Ontario, Canada.)

It can thus be appreciated that, in various examples, the recreational body of water is provided with one or more sensor(s) configured to emit pulses, waves, and/or radiation underwater so as to directly detect the presence or absence of a bather in the water.

When a RADAR sensor is used, the recreational body of water preferably is equipped with such a sensor. The RADAR sensor, for example, can emit electromagnetic waves (e.g., microwaves or radio waves) that travel through the air and then bounce off an object in the path of the waves and thereby reflect back to a receiver of the sensor. In such cases, the RADAR sensor preferably comprises an antenna, and the receiver may use the same antenna as the transmitter. The time it takes for the waves to return to the sensor is used to calculate the distance between the sensor and an object in the path of the emitted waves. The RADAR sensor can thus detect the presence of a bather at the surface of the water by reflection of the RADAR waves from the exposed body of the bather.

A RADAR sensor can thus optionally be mounted above the surface of the water. In some cases, a sensor of this nature is integrated into an upper region (e.g., a region above the surface of the water) of a shell of a hot tub or spa.

One exemplary RADAR sensor is the PSENradar sensor, which is commercially available from Pilz Automation Safety L.P. (Canton, Michigan, USA).

When an optical sensor is used, the recreational body of water preferably is equipped with an optical emitter and an optical receiver. In such cases, the emitter may be configured to emit visible radiation toward the receiver. In embodiments involving a hot tub or spa, the emitter and receiver preferably are on opposite sides of the hot tub or spa. In some cases, the emitter and receiver are integrated into upper regions (e.g., regions above the surface of the water) on opposite sides of a shell of a hot tub or spa. If desired, a plurality of emitters may provide a light curtain that passes over the water. More generally, one or more emitters are configured to emit one or more beams of electromagnetic radiation toward one or more corresponding receivers. When a bather enters the water, the beam(s) are interrupted, and as a result the sensor (or a controller operably coupled with the sensor) preferably generates a signal that triggers an increased sanitizing and/or oxidizing operation for the water. Furthermore, various vision systems and/or cameras may be used. Optical sensors can be obtained from a wide variety of commercial suppliers, such as SICK Inc. (Minneapolis, Minnesota, USA).

It can thus be appreciated that, in various examples, the recreational body of water is provided with one or more sensor(s) configured to emit pulses, waves, and/or radiation through the air over (and adjacent to) the water of a pool, hot tub, spa, or other recreational body of water so as to directly detect the presence or absence of a bather at the surface of the water.

When a thermal/infrared sensor is used, it preferably involves an electro-optical imaging sensor configured to detect temperature differences between a bather and the surrounding water. An apparent temperature difference between the body of a bather and the water surface can provide thermal contrast. This can be detected using, for example, a thermal imaging sensor. A sensor of this nature can optionally be mounted above the surface of the water, e.g., such that its field of view includes a central area of the water surface of a hot tub or spa. In some cases, a sensor of this nature is integrated into an upper region (e.g., a region above the surface of the water) of a shell of a hot tub or spa. Various fixed-mount thermal cameras are available commercially, such as from Teledyne FLIR LLC (Wilsonville, Oregon, USA). One example is the FLIR A400 Smart Sensor.

Further, certain embodiments of the invention involve a water motion signal. When a water motion sensor is used, it may comprise an underwater motion sensor, a floating motion sensor, or both. Such a water motion sensor, for example, may include a buoy or other float, and/or a post (e.g., a sensor post projecting downwardly from a floating buoyant housing), a rudder switch, and/or another body configured to move in response to sufficient waves or other water motion and then generate a signal indicating that there is water motion indicative of bather presence. Preferably, the water motion sensor is configured such that a switch thereof is activated in response to water motion that is characteristic of one or more bathers entering the recreational body of water. Preferably, the water motion sensor has a sensitivity level that is adjustable, configured for a desired range of sizes for the recreational body of water, or both.

In some cases, a floating motion sensor is provided, and it may be operatively coupled wirelessly to a controller. One example of a floating motion sensor that may be configured and integrated to work with a controller system in accordance with certain embodiments of the present disclosure is the solar powered pool alarm (wave alarm) commercially available from Briidea (Fujian, China). In other cases, a water motion sensor is mounted on the side of a pool, or integrated into a shell of a hot tub or spa.

When provided, the water motion sensor can optionally comprise a sub-surface wave sensor, i.e., a water motion sensor configured to detect waves below the surface of the water. This may advantageously avoid rain or wind triggering the sensor. Conventional sensors of this nature are available commercially, such as from SPQ Brands (Lakewood, New Jersey, USA). Furthermore, exemplary sub-surface wave sensor technology is disclosed in GB2416899, entitled “Subsurface Wave Sensing Pool Alarm,” the contents of which are hereby incorporated by reference. It can thus be appreciated that a sub-surface wave sensor may comprise an underwater array (e.g., a vertical array) of two or more sensors, each configured to generate and/or initiate a subsurface wave signal or another signal or data. Other water motion sensor technologies are described in U.S. Pat. No. 5,903,218, entitled “Pool Alarm,” the contents of which are incorporated herein by reference. Still other water motion sensor technologies are described in U.S. Pat. No. 7,019,649, entitled “Pool Monitoring,” the contents of which are incorporated herein by reference.

Still further, certain embodiments of the invention involve a water level signal. When a water level sensor is used, it preferably is mounted in a stationary position (at least during use), e.g., along a side of a pool, hot tub, or spa. In embodiments involving a hot tub or spa, one or more water level sensors can optionally be operably coupled with (e.g., integrated into) a shell of the tub or spa.

In some cases, a water level sensor includes a magnetic float level switch. In such cases, when the water level rises by an amount indicative of one or more bathers entering the water, a float carrying a magnet moves upwardly with the rising water level to a point where it actuates an adjacent magnetically actuated output switch. In embodiments of this nature, when the output switch is thrown in this manner, it preferably generates (and/or a controller operably coupled thereto generates) a water level signal that triggers an increased sanitizing and/or oxidizing operation for the water.

In other cases, a magnetic float level transmitter is used. In such cases, a float mounted movably along a vertical sensor probe moves/floats upwardly along the probe when the water level rises. Magnets are included in the float, and a resistor chain is included in the probe. The resulting change in resistance can be used by a sensor head to calculate the water level. The sensor head, for example, may be located at a top end of the sensor probe. Once the calculations reflect the water surface having risen to a level predetermined to correspond to a water level characteristic of one or more bathers being in the water, the sensor (and/or a controller operably coupled thereto) preferably generates a water level signal that triggers an increased sanitizing and/or oxidizing operation for the water.

In still other cases, an ultrasonic level transmitter or a RADAR level transmitter is used. When an ultrasonic level transmitter is used, it includes an ultrasonic transducer that transmits sound waves at the surface of the water. The sound waves bounce off the surface of the water, and the sensor measures the intervals of time between transmitting the sound waves and receiving their bounce-back. This is used to calculate a distance between the transducer and the surface of the water. The same technique may be used with a RADAR level transmitter, which involves a transducer configured to direct electromagnetic waves (e.g., microwaves or radio waves) at the surface of the water. Some of this electromagnetic radiation reflects off the surface of the water and is received by the sensor. The time involved for this to happen can be used to calculate a distance between the transducer and the surface of the water. Regardless of which radiation type is used, once the calculations reveal that the water surface has risen to a level predetermined to correspond to a water level characteristic of one or more bathers being in the water, the sensor (and/or a controller operably coupled thereto) preferably generates a water level signal that triggers an increased sanitizing and/or oxidizing operation for the water.

Further yet, certain embodiments of the invention involve a vibration signal. Thus, a vibration sensor can be used, for example, with a hot tub or spa. In embodiments of this nature, the vibration sensor (and/or a controller operably coupled thereto) is configured to generate a signal when it vibrates to an extent characteristic of one or more bathers entering the hot tub or spa. The signal triggers an increased sanitizing and/or oxidizing operation for the water. In some cases, a vibration sensor is operably coupled with (e.g., integrated into) a shell of the hot tub or spa. Suitable vibration sensors are available from a variety of commercial suppliers, such as SignalQuest, LLC (Lebanon, New Hampshire, USA).

In some embodiments of the invention, the one or more trigger conditions comprise a bather-use jets operation. These embodiments typically involve a hot tub or spa. As is well known, hot tubs and spas typically either include: (1) at least two different pumps, including at least one water circulation pump and at least one water jet pump (“high-speed jet pump”), or (2) a multi-speed water pump having at least two speeds, including a circulation speed and a jet speed, where the jet speed is greater than the circulation speed. In the present embodiments, the bather-use jets operation involves operating (e.g., by an operator activating) one or more non-circulation water pumps, e.g., one or more jet pumps (or operating a multi-speed water pump at jet speed). Typically, one or more people bathe in the water while such water pump(s) are operating. Thus, there are typically one or more bathers in the water during at least part of the bather-use jets operation. Accordingly, in the present embodiments, there are typically one or more bathers in the water during at least part of the increased sanitizing and/or oxidizing operation that is initiated by the automated response to the bather-use jets operation.

In more detail, the bather-use jets operation will commonly continue for more than 5 minutes, or more than 10 minutes. In some cases, the bather-use jets operation will continue for more than 15 minutes. Thus, for a bather-use jets operation to trigger the automated response, the operation may need to involve high-speed operation of one or more water pumps (e.g., continuously) at least for a time period in any one or more of the noted time ranges.

In some cases, a bather will actuate high-speed operation of such water pump(s) by manually activating one or more controls for the hot tub or spa. This may involve, for example, pressing a button, rotating a control dial, or rotating an outer ring on each such jet. Various other user interfaces, such as a control panel, touchscreen, and/or cell phone app, can also be used. Thus, the bather-use jets operation of one or more water pump(s) may occur in response to a bather manually activating: (i) one or more jet pump(s), and/or (ii) jet-speed operation of one or more multi-speed water pumps.

Typically, the one or more jet pumps (or the one or more multi-speed water pumps) are configured (and in some of the present methods, are operated) to move more than 50 gallons of water per minute, optionally more than 100 gallons of water per minute, or in some cases more than 200 gallons of water per minute. In contrast, water circulation pumps (or multi-speed water pumps operating at circulation speed, which is lower than jet speed) preferably move fewer than 50 gallons of water per minute, such as about 10-35 gallons of water per minute. Thus, for any embodiment where the trigger condition is a bather-use jets operation, the triggering operation can optionally comprise operating one or more water pumps to move more than 50 gallons of water per minute, perhaps more than 100 gallons of water per minute, or in some cases more than 200 gallons of water per minute. Typically, one or more bathers are in the hot tub or spa during at least part of this jets operation.

In other embodiments of the invention, the one or more trigger conditions comprise a bather-use heater operation. The bather-use heater operation is an operation of the heater that is indicative of one or more bathers having entered the water and thereby having caused a rapid decrease of the water temperature. In some cases, in response to a water cooling time between certain high and low temperatures being markedly shorter (e.g., by at least certain amount of time, optionally a predetermined amount of time) than a prior water cooling interval (or an average of prior intervals, or a predetermined standard interval), the controller initiates an increased sanitizing and/or oxidizing operation. In such cases, the markedly shorter water cooling interval is indicative of one or more bathers entering the water and thereby causing a rapid and unpredictable decrease of the water temperature. In these cases, the recreational body of water will typically comprise a hot tub or spa.

In view of the foregoing examples, it can be appreciated that the present method can involve different types of trigger conditions. Regardless of the trigger condition(s) involved, the automated response preferably initiates an increased sanitizing and/or oxidizing operation at a time when one or more bathers are preparing to enter the recreational body of water, are entering the water, or are bathing in the water. Thus, the present method will preferably include a person being in the recreational body of water at a time when the automated response has already initiated the increased sanitizing and/or oxidizing operation.

This beneficially provides a preemptive measure compared with simply pressing a conventional boost button after bathing is complete. It also advantageously automates the increased sanitizing and/or oxidizing operation, thereby eliminating some potential for user error, such as a bather forgetting to press a conventional boost button after bathing.

In embodiments where the recreational body of water comprises a swimming pool, hot tub, or spa, it preferably is equipped with a controller. In such cases, the method preferably includes the controller operating to initiate the automated response. In certain embodiments, the controller is operably connected with one or more sensors of the nature described above.

Suitable controllers for pools, hot tubs, or spas are available from a variety of commercial suppliers. One example is the EASYTOUCH® control system, which is commercially available from Pentair (Golden Valley, Minnesota, USA). Another example is the Blu-Sentinel™ chemical controller, which is commercially available from Evoqua (Pittsburgh, Pennsylvania, USA).

As will be appreciated by skilled artisans, conventional controllers for pools, hot tubs, or spas have (e.g., are configured to receive) a number of common inputs. With a hot tub, for example, common inputs include a high-limit sensor, a flow switch, and a pressure switch. In addition to the present controller having one or more (e.g., any combination, or all) of the noted conventional inputs, it preferably has (e.g., is configured to receive) one or more auto-boost sensory inputs selected from the group consisting of a direct occupancy signal, a water motion signal, a water level signal, a vibration signal, a temperature signal, a blower signal, and a pump speed.

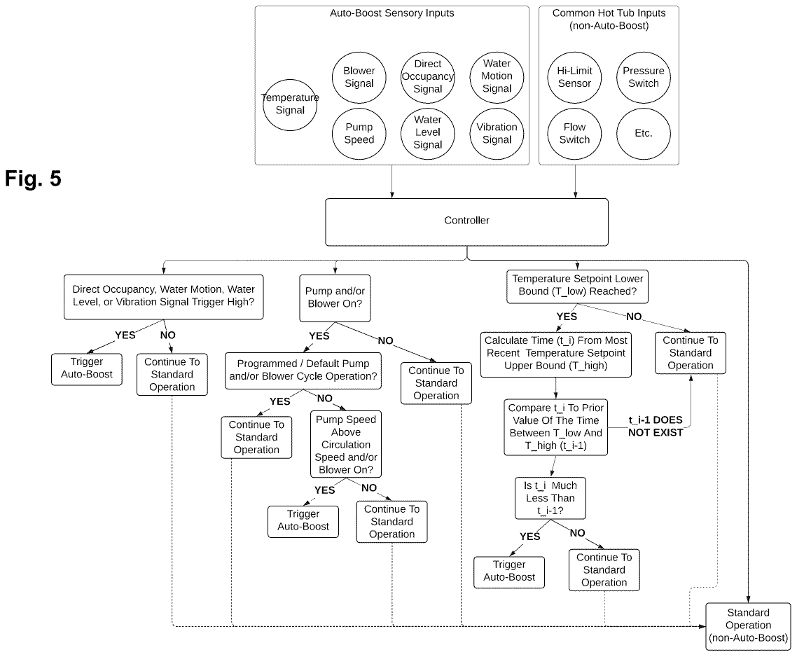

Reference is made to FIG. 5, which schematically illustrates a logic tree for a controller of a system comprising a recreational body of water, where the controller is configured to receive one or more auto-boost sensory inputs selected from the group consisting of a direct occupancy signal, a water motion signal, a water level signal, a vibration signal, a temperature signal, a blower signal, and a pump speed in accordance with various embodiments of this disclosure

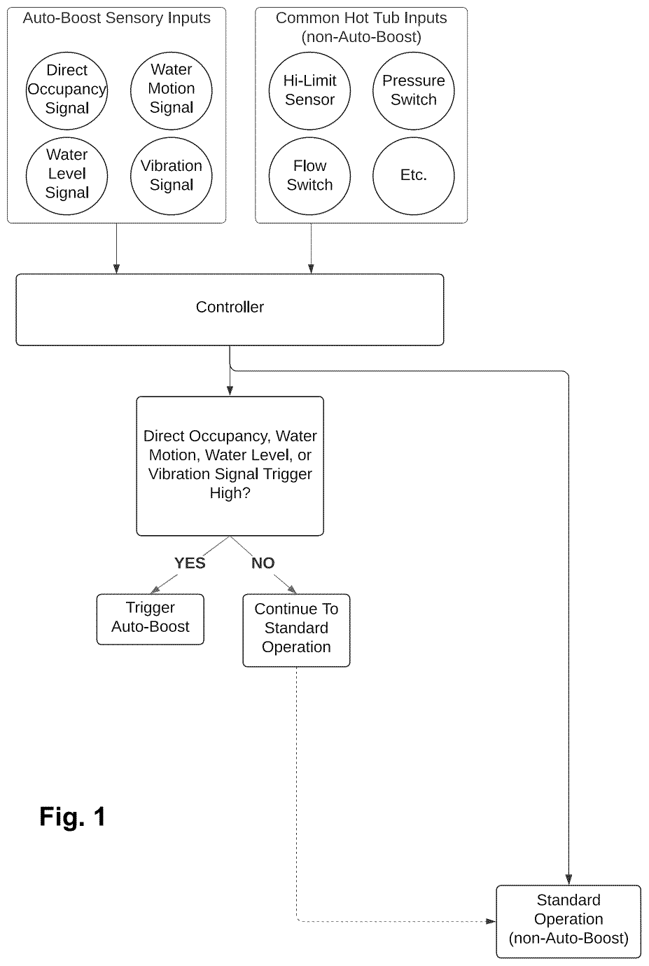

In a first subgroup of embodiments, the controller has (e.g., is configured to receive) one or more auto-boost sensory inputs selected from the group consisting of a direct occupancy signal, a water motion signal, a water level signal, and a vibration signal. Reference is made to FIG. 1, which schematically depicts one non-limiting example of a logic tree for this subgroup of embodiments. While FIG. 1 shows four possible auto-boost sensory inputs, it is to be appreciated that the system and method in these embodiments can include any one or more of these auto-boost sensory inputs. In some cases, it will include only one of these auto-boost sensory inputs. This can optionally be the case for any embodiment of the present subgroup. In other cases, it will include any two (or more) of these auto-boost sensory inputs. The auto-boost sensory input(s) are provided in addition to one or more (e.g., any combination, or all) of the noted conventional inputs.

Preferably, in the present subgroup of embodiments, the recreational body of water comprises a swimming pool, hot tub, or spa equipped with one or more sensors selected from the group consisting of a direct occupancy sensor, a water motion sensor, a water level sensor, and a vibration sensor. In such embodiments, the swimming pool, hot tub, or spa preferably is equipped with a controller, and the method includes the controller operating to: (i) receive at least one of the noted signal types from at least one of the noted sensor types, and (ii) initiate the automated response.

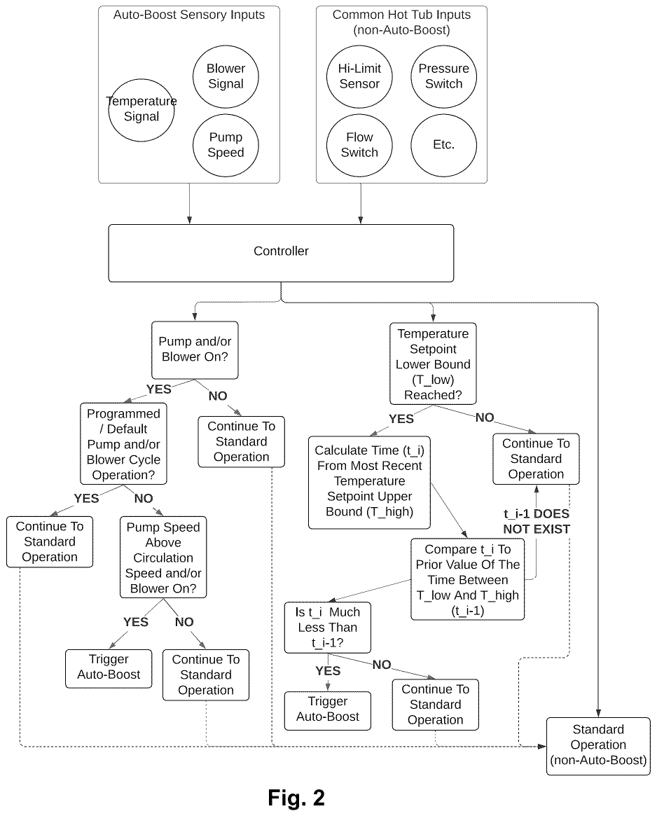

In a second subgroup of embodiments, the controller has (e.g., is configured to receive) one or more auto-boost sensory inputs selected from the group consisting of a water temperature signal, a blower signal, and a water pump speed. Reference is made to FIG. 2, which schematically depicts one non-limiting example of a logic tree for this subgroup of embodiments. While FIG. 2 shows three possible auto-boost sensory inputs, it is to be appreciated that the system and method in these embodiments can include any one or more of these auto-boost sensory inputs. In some cases, it will include only one of these inputs, e.g., only water temperature signal. In other cases, it will include only two of these inputs, e.g., only blower signal and pump speed. The auto-boost sensory input(s) are provided in addition to one or more (e.g., any combination, or all) of the noted conventional inputs.

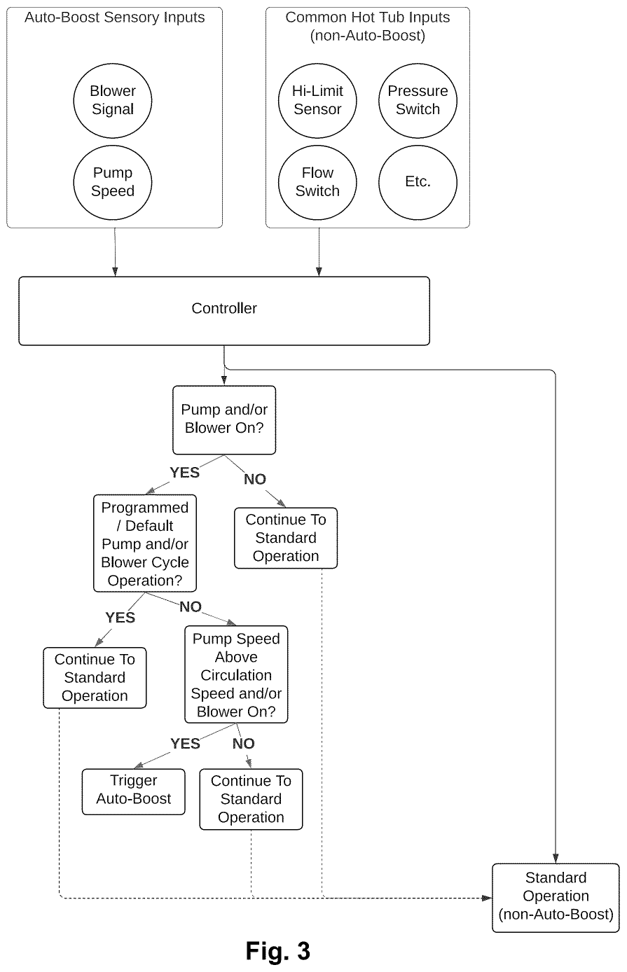

Within this subgroup of embodiments, one embodiment involves the controller having (e.g., being configured to receive) one or more auto-boost sensory inputs comprising a blower signal, a pump speed, or both. Reference is made to FIG. 3, which schematically depicts one non-limiting example of a logic tree for this embodiment. Here, the one or more trigger conditions comprise a bather-use jets operation, and thus the recreational body of water is typically a hot tub or spa.

With continued reference to FIG. 3, there is shown one non-limiting example for how the logic of a controller may be configured and operated. Given this teaching as a guide, it will be appreciated that the controller in the present embodiment receives blower signal and/or pump speed inputs to assess whether one or more bathers are using the hot tub or spa. As charted in FIG. 3, in response to the pump speed being above circulation speed and/or a blower being on, at a time when there is no programmed/default pump operation above circulation speed or programmed/default blower operation, the controller initiates an increased sanitizing and/or oxidizing operation. It will be appreciated, of course, that some hot tubs and spas do not include a blower.

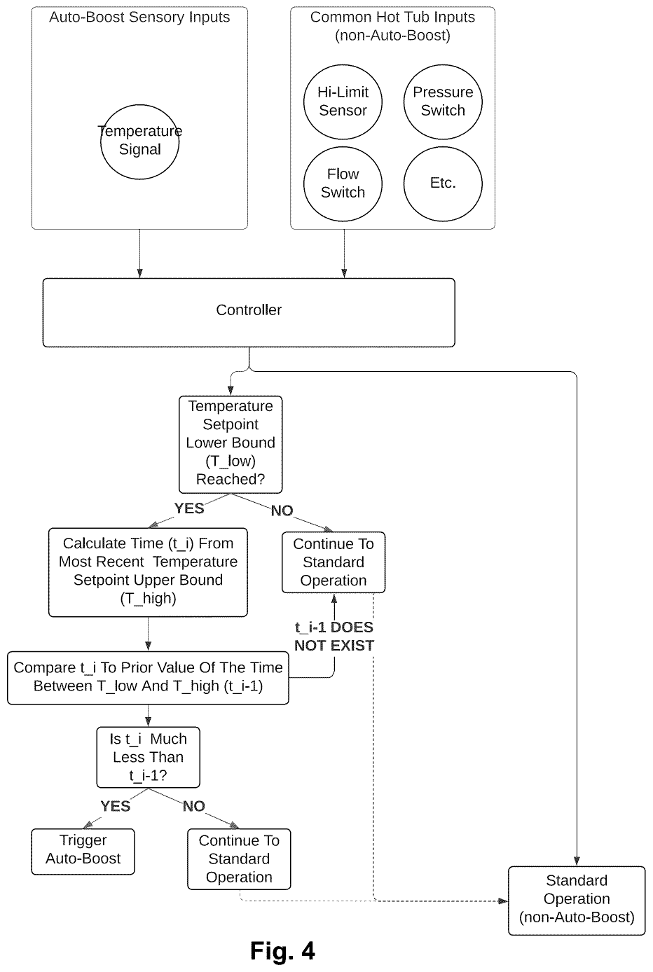

Another embodiment of the present subgroup involves the controller having (e.g., being configured to receive) an auto-boost sensory input comprising a water temperature signal. Reference is made to FIG. 4, which schematically depicts one non-limiting example of a logic tree for this embodiment. Here, the one or more trigger conditions comprise a bather-use heater operation.

With continued reference to FIG. 4, there is shown one non-limiting example for how the logic of a controller may be configured and operated. Given this teaching as a guide, it will be appreciated that the controller receives a temperature signal input to assess whether one or more bathers are using the hot tub or spa. As charted in FIG. 4, in response to the water cooling time between certain high and low temperatures being markedly shorter (e.g., by at least certain amount of time, optionally a predetermined amount of time) than a prior water cooling interval (or an average of prior intervals, or a predetermined standard interval), the controller initiates an increased sanitizing and/or oxidizing operation. In such cases, the markedly shorter water cooling interval is indicative of one or more bathers entering the water and thereby causing a rapid and unpredictable decrease of the water temperature. In some cases, the recreational body of water in the present embodiment comprises a hot tub or spa.

The foregoing logic trees show several non-limiting examples. If desired, however, they may be more involved, e.g., with error-proofing. Furthermore, the automated response initiating the increased sanitizing and/or oxidizing operation can optionally be triggered by two or more trigger conditions of any types described herein. As just one such example, a controller can be configured to initiate the increased sanitizing and/or oxidizing operation in response to both a bather-use jets operation and a bather-use heater operation occurring within a predetermined time of each other.

In embodiments where the recreational body of water is a hot tub or spa that includes a cabinet, and the controller can optionally be integrated into the cabinet.

Preferably, the recreational body of water is further equipped with an automated water-treatment device, which is operably coupled with a controller. In more detail, the automated water-treatment device preferably is selected from the group consisting of: a chlorine generator, a bromine generator, a chemical erosion feeder, a bleach pump, a venturi bleach feeder, a chlorine gas feeder, an ozone generator, a germicidal lamp, and an advanced oxidation process (AOP) device.

Thus, in certain embodiments, the recreational body of water is equipped with an electrolytic chlorine generator. In such cases, the increased sanitizing and/or oxidizing operation preferably involves: (i) increasing an amount of time (e.g., increasing run time length and/or increasing overall run time per day or other period of time) during which the electrolytic chlorine generator is operated, and/or (ii) increasing the amperage at which the electrolytic chlorine generator is operated.

Advantageous electrolytic chlorine generators are described in U.S. patent application Ser. No. 63/683,112, entitled “Water Sanitation System,” the contents of which are incorporated herein by reference. In addition, conventional chlorine generators are available from a variety of commercial suppliers. One example is the Freshwater™ chlorine generator, which is commercially available from Watkins Wellness (Vista, California, USA). Some other examples of systems that include a suitable electrolytic salt chlorine generator (e.g., the 3-Plate Electrode salt cell cartridge) are commercially available from Arctic Spas® (Blue Falls Manufacturing, of Thorsby, Alberta, Canada), e.g., in connection with their trade names Spa Boy® and Onzen™. Still other electrolytic salt chlorine generators are commercially available from Pentair.

In some embodiments, the recreational body of water comprises a swimming pool, hot tub, or spa equipped with both a controller and an electrolytic chlorine generator. In such cases, the electrolytic chlorine generator is operably coupled with the controller, and the method includes operating the controller and the electrolytic chlorine generator to initiate the automated response by providing a signal from the controller to the electrolytic chlorine generator.

In the subgroup of embodiments wherein the automated water-treatment device comprises an electrolytic chlorine generator, the water of the recreational body of water preferably comprises salt water. In any such embodiment (e.g., wherein a swimming pool, hot tub, or spa contains salt water), in order to form the salt water therein, the method preferably includes adding sodium chloride, such as by adding pool salt, to the recreational body of water. In such cases, the method can optionally also include, during an initial stage that includes providing fresh water (e.g., filling a swimming pool, hot tub, or spa with fresh water), adding chlorine in another form, such as by adding bleach or calcium hypochlorite (optionally bringing a total chlorine level in the water to a range of about 1-20 ppm, perhaps 3-5 ppm). Thus, in embodiments involving salt water, an electrolytic chlorine generator preferably is coupled operatively with the recreational body of water. Accordingly, the present methods can be performed with a pool, hot tub, or spa filled with salt water. It is to be appreciated, however, that the embodiments and methods of this disclosure are by no means limited to salt water.

Further, in certain embodiments, the recreational body of water is equipped with an electrolytic bromine generator. In such cases, the increased sanitizing and/or oxidizing operation preferably involves: (i) increasing an amount of time (e.g., increasing run time length and/or increasing overall run time per day or other period of time) during which the electrolytic bromine generator is operated, and/or (ii) increasing the amperage at which the electrolytic bromine generator is operated.

Suitable bromine generators are available from various commercial suppliers. One example is the Genesis bromine generator, which is commercially available from Pioneer H2O Technologies, Inc. (Lakewood, Colorado, USA).

In some embodiments, the recreational body of water comprises a swimming pool, hot tub, or spa equipped with both a controller and an electrolytic bromine generator. In such cases, the electrolytic bromine generator is operably coupled with the controller, and the method includes operating the controller and the electrolytic bromine generator to initiate the automated response by providing a signal from the controller to the electrolytic bromine generator.

As another example, the recreational body of water can optionally be equipped with a chemical erosion feeder. In some embodiments, the recreational body of water comprises a swimming pool, hot tub, or spa equipped with a controller, a chemical erosion feeder, and a pump configured to operate at different speeds and thereby move water through the chemical erosion feeder at different rates. In such cases, the pump is operably coupled with the controller, and the method includes operating the controller and the pump to initiate the automated response by providing a signal from the controller to the pump, so as to cause the pump to operate, or operate at a higher speed, and thereby deliver chemical(s), or increase the rate at which chemical(s) are delivered, from inside the chemical erosion feeder due to chemical erosion by water flowing through the feeder, whereby the chemical(s) are delivered into the body of water, or delivered at an increased rate.

In some cases, the method uses a conventional in-line chemical erosion system as the automated water-treatment device. In such cases, in response to the noted trigger condition(s), the method comprises increasing a flow rate (e.g., at least doubling the flow rate, or at least tripling the flow rate) of water through the chemical erosion feeder to provide the increased sanitizing and/or oxidizing operation. One advantageous in-line chemical erosion system is the FROG® @ease® in-line system, which is commercially available from King Technology, Inc. (Minnetonka, Minnesota, U.S.A.). In such cases, the chemical erosion feeder can comprise one or two chemical erosion cartridges, such as the SmartChlor® (chlorine based erosion system) and mineral cartridges from King Technology, or the Frog Serene® (bromine based erosion system) and mineral cartridges from King Technology.

In other cases, when a chemical erosion feeder is provided, it is operably coupled with a separate water pump configured to deliver water flow through the chemical erosion feeder and thereby deliver chemical(s) from the feeder into water flowing through the feeder, whereby the chemical(s) are dispersed into the body of water. In such cases, the separate water pump can optionally be coupled with a motorized ball valve to facilitate delivering the increased sanitizing and/or oxidizing operation in response to the noted trigger condition(s). Various conventional chemical erosion feeder can be used in these embodiments.

Still further, in certain embodiments, the recreational body of water is equipped with a bleach pump. A variety of dosing pumps (e.g., peristaltic dosing pumps) can be provided to dose bleach into the water. If desired, a constant volume pump can be used, such as a 110v 4-roller peristaltic dosing pump. Suitable dosing pumps are available from various commercial suppliers, such as the Stenner Pump Company (Jacksonville, Florida, USA).

Further yet, in certain embodiments, the recreational body of water is equipped with a venturi bleach feeder. One suitable venturi feeder is sold commercially as THE SOLUTION feed system (Model 22152-01), which is available from SureWater Technologies Inc. (Winter Garden, Florida, USA). In embodiments of this nature, controller automation preferably includes an electrical connection to a solenoid valve of the venturi feeder.

Still further, in certain embodiments, the recreational body of water is equipped with a chlorine gas feeder. Chlorine gas feeders suitable for swimming pools are commercially available from Evoqua Water Technologies LLC (Pittsburgh, Pennsylvania, USA).

Further yet, in certain embodiments, the recreational body of water is equipped with an ozone generator. One suitable ozone generator is the CircuPool® INDIGO3 ozone generator, which is commercially available from CircuPool Systems (Waller, Texas, USA).

Still further, in certain embodiments, the recreational body of water is equipped with a germicidal lamp. One suitable UV generator is the Delta UV® E Series disinfection system, which is commercially available from Evoqua Water Technologies LLC (Pittsburgh, Pennsylvania, USA). Another suitable UV generator is the Balboa Ultrazo₃ne™ sanitation system, which is commercially available from Balboa Water Group (Costa Mesa, California, USA).

Finally, in certain embodiments, the recreational body of water is equipped with an advanced oxidation process (AOP) device. Suitable AOP systems are sold commercially as the Clear Comfort AOP systems (such as models CCW25, CCW50, and CCW100 Dual), which are commercially available from Clear Comfort Water, Inc. (Louisville, Colorado, USA).

More generally, the present methods can be used with any desired automated water-treatment devices suitable for carrying out the desired increased sanitizing and/or oxidizing operation.

If desired, the recreational body of water can be equipped with two or more automated water-treatment devices. In some cases, both a chlorine generator and a germicidal lamp are provided. In still other cases, both a chlorine generator and an ozone generator are provided. In other cases, both a bromine generator and an ozone generator are provided. These are just a few possible examples. Other combinations will be apparent to skilled artisans, given the present teaching as a guide.

Thus, the present disclosure provides an automated method for preemptively inhibiting microorganism growth in a recreational body of water. In certain embodiments, the method comprises initiating an increased sanitizing and/or oxidizing operation for the water as an automated response to two or more trigger conditions. To trigger the automated response, it may be required that the two or more trigger conditions occur at the same time or within a certain predetermined amount of time. The two or more trigger conditions are selected from: a direct occupancy signal, a water motion signal, a water level signal, a vibration signal, a bather-use jets operation, and a bather-use heater operation. In some of these embodiments, the two or more trigger conditions are selected from: at least one of (i) a direct occupancy signal, a water motion signal, a water level signal, and a vibration signal: and at least one of (ii) a bather-use jets operation and a bather-use heater operation. In embodiments of this nature, the recreational body of water preferably comprises a swimming pool, hot tub, or spa equipped with a controller, and the controller preferably is configured to receive two or more auto-boost sensory inputs selected from: at least one of (a) a direct occupancy signal, a water motion signal, a water level signal, and a vibration signal: and at least one of (b) a temperature signal, a blower signal, and a pump speed. In such embodiments, the swimming pool, hot tub, or spa preferably is equipped with a direct occupancy sensor, a water motion sensor, a water level sensor, and/or a vibration sensor. In certain embodiments of this nature, the recreational body of water comprises a hot tub or spa equipped with a controller, the two or more trigger conditions include the bather-use heater operation, and the controller is configured to receive an auto-boost sensory input comprising a water temperature signal. Additionally or alternatively, the two or more trigger conditions can include the bather-use jets operation, while the controller is configured to receive one or more auto-boost sensory inputs comprising a blower signal and/or a pump speed.

Thus, in various embodiments of this disclosure, the invention provides automated methods for preemptively inhibiting microorganism growth in a recreational body of water. As noted above, the recreational body of water can advantageously be a swimming pool, hot tub, or spa. Furthermore, certain embodiments provide a recreational body of water (e.g., a swimming pool, hot tub, or spa) that is adapted to carry out any method of the present disclosure. Thus, a swimming pool, hot tub, or spa can be adapted (e.g., equipped and configured) to initiate an increased sanitizing and/or oxidizing operation for the water as an automated response to one or more trigger conditions of the type noted herein. In such cases, the swimming pool, hot tub, or spa can advantageously be equipped with a controller configured to initiate the increased sanitizing and/or oxidizing operation. In addition, the swimming pool, hot tub, or spa is preferably equipped with an automated water-treatment device of any type noted herein. Preferably, the automated water-treatment device is operably coupled with the controller, as noted above. Furthermore, some embodiments provide one or more sensors (e.g., of any one or more types described above) operably coupled with the controller.

Various embodiments are described. These and other embodiments are within the scope of the following embodiments and claims.

### EMBODIMENTS

1. An automated method for preemptively inhibiting microorganism growth in a recreational body of water, the method comprising:
initiating an increased sanitizing and/or oxidizing operation for the water as an automated response to one or more trigger conditions, the one or more trigger conditions selected from: a direct occupancy signal, a water motion signal, a water level signal, and a vibration signal.

2. The method of embodiment 1 wherein the automated response initiating the increased sanitizing and/or oxidizing operation occurs while one or more bathers are in the recreational body of water.

3. The method of embodiment 1 or 2 wherein the automated response initiating the increased sanitizing and/or oxidizing operation occurs when one or more bathers enter the recreational body of water.

4. The method of any one of the preceding embodiments wherein the recreational body of water is provided with one or more sensors configured to emit pulses, waves, and/or radiation underwater so as to directly detect the presence or absence of a bather in the recreational body of water.

5. The method of any one of the preceding embodiments wherein the recreational body of water is a swimming pool, hot tub, or spa.

6. The method of embodiment 5 wherein the swimming pool, hot tub, or spa is equipped with a controller, and the method includes operating the controller to initiate the automated response.

7. The method of embodiment 6 wherein the swimming pool, hot tub, or spa is further equipped with an automated water-treatment device, and the automated water-treatment device is operably coupled with the controller, the automated water-treatment device selected from the group consisting of a chlorine generator, a bromine generator, a chemical erosion feeder, a bleach pump, a venturi bleach feeder, a chlorine gas feeder, an ozone generator, a germicidal lamp, and an advanced oxidation process (AOP) device.

8. The method of embodiment 6 or 7 wherein the recreational body of water is a hot tub or spa that includes a cabinet, and the controller is integrated into the cabinet.

9. The method of any one of the preceding embodiments wherein the swimming pool, hot tub, or spa is equipped with a controller and an electrolytic chlorine generator, the electrolytic chlorine generator is operably coupled with the controller, and the method includes operating the controller and the electrolytic chlorine generator to initiate the automated response by providing a signal from the controller to the electrolytic chlorine generator.

10. The method of any one of the preceding embodiments wherein the swimming pool, hot tub, or spa is equipped with a controller, and the method includes operating the controller to: (i) receive at least one of the signals from at least one sensor, and (ii) initiate the automated response.

11. The method of any one of the preceding embodiments wherein the swimming pool, hot tub, or spa is equipped with a direct occupancy sensor selected from the group consisting of a sonar sensor, a LiDAR sensor, a RADAR sensor, an optical sensor, and a thermal/infrared sensor.

12. The method of any one of the preceding embodiments wherein the recreational body of water is a hot tub or spa equipped with a water level sensor.

13. The method of any one of the preceding embodiments wherein the hot tub or spa includes a shell, and the water level sensor is integrated into the shell.

14. The method of any one of the preceding embodiments wherein the recreational body of water is a hot tub or spa equipped with a vibration sensor.

15. The method of any one of the preceding embodiments wherein the hot tub or spa includes a shell, and the vibration sensor is integrated into the shell.

16. The method of any one of the preceding embodiments wherein the recreational body of water is equipped with an electrolytic chlorine generator, and the increased sanitizing and/or oxidizing operation involves: (i) increasing an amount of time during which the electrolytic chlorine generator is operated, and/or (ii) increasing an amperage at which the electrolytic chlorine generator is operated.

17. An automated method for preemptively inhibiting microorganism growth in a recreational body of water, the method comprising:
initiating an increased sanitizing and/or oxidizing operation for the water as an automated response to one or more trigger conditions, the one or more trigger conditions selected from: a bather-use jets operation and a bather-use heater operation.

18. The method of embodiment 17 wherein the automated response initiating the increased sanitizing and/or oxidizing operation occurs while one or more bathers are in the recreational body of water.

19. The method of embodiment 17 or 18 wherein the automated response initiating the increased sanitizing and/or oxidizing operation occurs when one or more bathers enter the recreational body of water.

20. The method of any one of the preceding embodiments wherein the recreational body of water is a swimming pool, hot tub, or spa.

21. The method of embodiment 20 wherein the swimming pool, hot tub, or spa is equipped with a controller, and the method includes operating the controller to initiate the automated response.

22. The method of embodiment 21 wherein the swimming pool, hot tub, or spa is further equipped with an automated water-treatment device, and the automated water-treatment device is operably coupled with the controller, the automated water-treatment device selected from the group consisting of a chlorine generator, a bromine generator, a chemical erosion feeder, a bleach pump, a venturi bleach feeder, a chlorine gas feeder, an ozone generator, a germicidal lamp, and an advanced oxidation process (AOP) device.

23. The method of embodiment 21 or 22 wherein the recreational body of water is a hot tub or spa that includes a cabinet, and the controller is integrated into the cabinet.

24. The method of any one of the preceding embodiments wherein the swimming pool, hot tub, or spa is equipped with a controller and an electrolytic chlorine generator, the electrolytic chlorine generator is operably coupled with the controller, and the method includes operating the controller and the electrolytic chlorine generator to initiate the automated response by providing a signal from the controller to the electrolytic chlorine generator.

25. The method of any one of the preceding embodiments wherein the swimming pool, hot tub, or spa is equipped with an electrolytic chlorine generator, and the increased sanitizing and/or oxidizing operation involves: (i) increasing an amount of time during which the electrolytic chlorine generator is operated, and/or (ii) increasing an amperage at which the electrolytic chlorine generator is operated.

26. The method of any one of the preceding embodiments wherein the swimming pool, hot tub, or spa is equipped with a controller, the one or more trigger conditions comprise a bather-use jets operation, and the controller is configured to receive auto-boost sensory input comprising a blower signal and/or a pump speed.

27. The method of any one of the preceding embodiments wherein the swimming pool, hot tub, or spa is equipped with a controller, the one or more trigger conditions comprise a bather-use heater operation, and the controller is configured to receive auto-boost sensory input comprising a water temperature signal.

28. An automated method for preemptively inhibiting microorganism growth in a recreational body of water, the method comprising:
initiating an increased sanitizing and/or oxidizing operation for the water as an automated response to two or more trigger conditions, the two or more trigger conditions selected from: a direct occupancy signal, a water motion signal, a water level signal, a vibration signal, a bather-use jets operation, and a bather-use heater operation.

29. The method of embodiment 28 wherein the two or more trigger conditions are selected from:
at least one of (i) a direct occupancy signal, a water motion signal, a water level signal, and a vibration signal,
and at least one of (ii) a bather-use jets operation and a bather-use heater operation.

30. The method of embodiment 28 or 29 wherein the recreational body of water comprises a swimming pool, hot tub, or spa equipped with a controller, the controller configured to receive two or more auto-boost sensory inputs selected from:
at least one of (a) a direct occupancy signal, a water motion signal, a water level signal, and a vibration signal,
and at least one of (b) a temperature signal, a blower signal, and a pump speed.

31. The method of embodiment 30 wherein the swimming pool, hot tub, or spa is equipped with a direct occupancy sensor, a water motion sensor, a water level sensor, or a vibration sensor.

32. The method of any one of the preceding embodiments wherein the recreational body of water comprises a hot tub or spa equipped with a controller, the two or more trigger conditions include the bather-use heater operation, and the controller is configured to receive an auto-boost sensory input comprising a water temperature signal.

33. The method of any one of the preceding embodiments wherein the recreational body of water comprises a hot tub or spa equipped with a controller, the two or more trigger conditions include the bather-use jets operation, and the controller is configured to receive one or more auto-boost sensory inputs comprising a blower signal and/or a pump speed.

34. The method of any one of the preceding embodiments wherein the swimming pool, hot tub, or spa is further equipped with an automated water-treatment device, and the automated water-treatment device is operably coupled with the controller, the automated water-treatment device selected from the group consisting of a chlorine generator, a bromine generator, a chemical erosion feeder, a bleach pump, a venturi bleach feeder, a chlorine gas feeder, an ozone generator, a germicidal lamp, and an advanced oxidation process (AOP) device.

What is claimed is:

1. An automated method for preemptively inhibiting microorganism growth in a
recreational body of water, the method comprising:
initiating an increased sanitizing and/or oxidizing operation for the water as an automated response to one or more trigger conditions, the one or more trigger conditions selected from: a direct occupancy signal, a water motion signal, a water level signal, and a vibration signal.

2. The method of claim 1 wherein the automated response initiating the increased sanitizing and/or oxidizing operation occurs while one or more bathers are in the recreational body of water.

3. The method of claim 1 wherein the automated response initiating the increased sanitizing and/or oxidizing operation occurs when one or more bathers enter the recreational body of water.

4. The method of claim 1 wherein the recreational body of water is provided with one or more sensors configured to emit pulses, waves, and/or radiation underwater so as to directly detect the presence or absence of a bather in the recreational body of water.

5. The method of claim 1 wherein the recreational body of water is a swimming pool, hot tub, or spa.

6. The method of claim 5 wherein the swimming pool, hot tub, or spa is equipped with a controller, and the method includes operating the controller to initiate the automated response.

7. The method of claim 6 wherein the swimming pool, hot tub, or spa is further equipped with an automated water-treatment device, and the automated water-treatment device is operably coupled with the controller, the automated water-treatment device selected from the group consisting of a chlorine generator, a bromine generator, a chemical erosion feeder, a bleach pump, a venturi bleach feeder, a chlorine gas feeder, an ozone generator, a germicidal lamp, and an advanced oxidation process (AOP) device.

8. The method of claim 6 wherein the recreational body of water is a hot tub or spa that includes a cabinet, and the controller is integrated into the cabinet.

9. The method of claim 5 wherein the swimming pool, hot tub, or spa is equipped with a controller and an electrolytic chlorine generator, the electrolytic chlorine generator is operably coupled with the controller, and the method includes operating the controller and the electrolytic chlorine generator to initiate the automated response by providing a signal from the controller to the electrolytic chlorine generator.

10. The method of claim 5 wherein the swimming pool, hot tub, or spa is equipped with a controller, and the method includes operating the controller to: (i) receive at least one of the signals from at least one sensor, and (ii) initiate the automated response.

11. The method of claim 5 wherein the swimming pool, hot tub, or spa is equipped with a direct occupancy sensor selected from the group consisting of a sonar sensor, a LiDAR sensor, a RADAR sensor, an optical sensor, and a thermal/infrared sensor.

12. The method of claim 1 wherein the recreational body of water is a hot tub or spa equipped with a water level sensor.

13. The method of claim 12 wherein the hot tub or spa includes a shell, and the water level sensor is integrated into the shell.

14. The method of claim 1 wherein the recreational body of water is a hot tub or spa equipped with a vibration sensor.

15. The method of claim 14 wherein the hot tub or spa includes a shell, and the vibration sensor is integrated into the shell.

16. The method of claim 1 wherein the recreational body of water is equipped with an electrolytic chlorine generator, and the increased sanitizing and/or oxidizing operation involves: (i) increasing an amount of time during which the electrolytic chlorine generator is operated, and/or (ii) increasing an amperage at which the electrolytic chlorine generator is operated.

17. An automated method for preemptively inhibiting microorganism growth in a recreational body of water, the method comprising:
initiating an increased sanitizing and/or oxidizing operation for the water as an automated response to one or more trigger conditions, the one or more trigger conditions selected from: a bather-use jets operation and a bather-use heater operation.

18. The method of claim 17 wherein the automated response initiating the increased sanitizing and/or oxidizing operation occurs while one or more bathers are in the recreational body of water.

19. The method of claim 17 wherein the automated response initiating the increased sanitizing and/or oxidizing operation occurs when one or more bathers enter the recreational body of water.

20. The method of claim 17 wherein the recreational body of water is a swimming pool, hot tub, or spa.

21. The method of claim 20 wherein the swimming pool, hot tub, or spa is equipped with a controller, and the method includes operating the controller to initiate the automated response.

22. The method of claim 21 wherein the swimming pool, hot tub, or spa is further equipped with an automated water-treatment device, and the automated water-treatment device is operably coupled with the controller, the automated water-treatment device selected from the group consisting of a chlorine generator, a bromine generator, a chemical erosion feeder, a bleach pump, a venturi bleach feeder, a chlorine gas feeder, an ozone generator, a germicidal lamp, and an advanced oxidation process (AOP) device.

23. The method of claim 21 wherein the recreational body of water is a hot tub or spa that includes a cabinet, and the controller is integrated into the cabinet.

24. The method of claim 20 wherein the swimming pool, hot tub, or spa is equipped with a controller and an electrolytic chlorine generator, the electrolytic chlorine generator is operably coupled with the controller, and the method includes operating the controller and the electrolytic chlorine generator to initiate the automated response by providing a signal from the controller to the electrolytic chlorine generator.

25. The method of claim 20 wherein the swimming pool, hot tub, or spa is equipped with an electrolytic chlorine generator, and the increased sanitizing and/or oxidizing operation involves: (i) increasing an amount of time during which the electrolytic chlorine generator is operated, and/or (ii) increasing an amperage at which the electrolytic chlorine generator is operated.

26. The method of claim 20 wherein the swimming pool, hot tub, or spa is equipped with a controller, the one or more trigger conditions comprise a bather-use jets operation, and the controller is configured to receive auto-boost sensory input comprising a blower signal and/or a pump speed.

27. The method of claim 20 wherein the swimming pool, hot tub, or spa is equipped with a controller, the one or more trigger conditions comprise a bather-use heater operation, and the controller is configured to receive auto-boost sensory input comprising a water temperature signal.

28. An automated method for preemptively inhibiting microorganism growth in a recreational body of water, the method comprising:
initiating an increased sanitizing and/or oxidizing operation for the water as an automated response to two or more trigger conditions, the two or more trigger conditions selected from: a direct occupancy signal, a water motion signal, a water level signal, a vibration signal, a bather-use jets operation, and a bather-use heater operation.

29. The method of claim 28 wherein the two or more trigger conditions are selected from:
at least one of (i) a direct occupancy signal, a water motion signal, a water level signal, and a vibration signal,
and at least one of (ii) a bather-use jets operation and a bather-use heater operation.

30. The method of claim 29 wherein the recreational body of water comprises a swimming pool, hot tub, or spa equipped with a controller, the controller configured to receive two or more auto-boost sensory inputs selected from:
at least one of (a) a direct occupancy signal, a water motion signal, a water level signal, and a vibration signal,
and at least one of (b) a temperature signal, a blower signal, and a pump speed.

31. The method of claim 30 wherein the swimming pool, hot tub, or spa is equipped with a direct occupancy sensor, a water motion sensor, a water level sensor, or a vibration sensor.

32. The method of claim 29 wherein the recreational body of water comprises a hot tub or spa equipped with a controller, the two or more trigger conditions include the bather-use heater operation, and the controller is configured to receive an auto-boost sensory input comprising a water temperature signal.

33. The method of claim 29 wherein the recreational body of water comprises a hot tub or spa equipped with a controller, the two or more trigger conditions include the bather-use jets operation, and the controller is configured to receive one or more auto-boost sensory inputs comprising a blower signal and/or a pump speed.

34. The method of claim 30 wherein the swimming pool, hot tub, or spa is further equipped with an automated water-treatment device, and the automated water-treatment device is operably coupled with the controller, the automated water-treatment device selected from the group consisting of a chlorine generator, a bromine generator, a chemical erosion feeder, a bleach pump, a venturi bleach feeder, a chlorine gas feeder, an ozone generator, a germicidal lamp, and an advanced oxidation process (AOP) device.
